(19) United States
(12) Patent Application Publication
(10) Pub. No.: US 2007/0218917 A1
(43) Pub. Date: Sep. 20, 2007

(54) Channel quality signaling

(75) Inventors: Frank Frederiksen, Klarup (DK); Troels Kolding, Klarup (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/717,698

(22) Filed: Mar. 14, 2007

(30) Foreign Application Priority Data
Mar. 20, 2006 (FI) 20065180

(51) Int. Cl. H04Q 7/20

(52) U.S. Cl. 455/450

(57) ABSTRACT

A solution for allocating frequency blocks in high-speed packet data transmission between a base station and a mobile station of a mobile telecommunication system utilizing an orthogonal frequency division multiplexing (OFDM) data transmission scheme in which data is transmitted in a plurality of frequency blocks, each frequency block comprising a plurality of OFDM subcarriers, is provided. According to the provided scheme, the mobile station calculates a coarse channel quality indicator CQI and at least one defining CQI for every frequency block. The defining CQI improves the resolution of the channel quality indicated by the coarse CQI. The mobile station transmits the coarse CQIs first to the base station for frequency block allocation and then the defining information contained in the defining CQIs. Accordingly, CQI reports may be transmitted with less number of bits, which reduces the amount of signaling.

### FIELD

The invention relates generally to high-speed data transmission in a mobile telecommunication system and particularly to a scheme for transmitting a channel quality indicator from a mobile station to a base station.

### BACKGROUND

The current working assumption in 3GPP (3^{rd} Generation Partnership Project) long-term evolution (LTE) is that a radio access technique in upcoming mobile telecommunication systems will be OFDM (Orthogonal Frequency Division Multiplexing), which will open doors for the opportunity to perform link-adaptation and user multiplexing in the frequency domain. In order to be able to perform this adaptation in the frequency domain, it is crucial that a packet scheduler and link adaptation units in Node B have knowledge of the instantaneous channel quality. This is obtained through the signaling of channel quality indication (CQI) reports from different mobile stations. Ideally, these CQI reports will be available with infinite resolution and ‘zero’ delay. However, this would require the uplink signaling bandwidth to be infinite. One approach to transmitting CQI values is to have the measured values quantized to an agreed set of levels, and transmitted with a certain delay.

It has been found out that in single carrier transmission a total number of 4 to 5 bits is needed per CQI report in order to achieve the best performance of the link adaptation/packet scheduling in the frequency domain. However, this approach might require a relative high uplink signaling bandwidth, as these measurement reports need be updated frequently, and a CQI report should comprise information on the quality of each frequency block employed. This means that the total number of bits would be as much as 5 bits multiplied with the number of frequency sub-bands. Therefore, the total number of bits per frequency sub-band should be decreased while not significantly degrading the performance of the link adaptation and packet scheduling.

### BRIEF DESCRIPTION OF THE INVENTION

An object of the invention is to provide an improved high-speed packet data transmission method in a mobile telecommunication system utilizing an orthogonal frequency division multiplexing (OFDM) data transmission scheme in which data is transmitted in a plurality of frequency blocks, each frequency block comprising a plurality of OFDM subcarriers.

According to an aspect of the invention, there is provided a high-speed packet data transmission method in a mobile telecommunication system utilizing an orthogonal frequency division multiplexing (OFDM) data transmission scheme in which data is transmitted in a plurality of frequency blocks, each frequency block comprising a plurality of OFDM subcarriers. The method comprises calculating, by a mobile station of the mobile telecommunication system, repeatedly a coarse channel quality indicator and at least one defining channel quality indicator for each of the plurality of frequency blocks on the basis of a reference signal transmitted from a serving base station to the mobile station, determining the type of channel quality indicator to be transmitted next from the mobile station to the base station, transmitting either the coarse channel quality indicator or a defining channel quality indicator for each of the plurality of frequency blocks from the mobile station to the serving base station, and allocating, by the serving base station on the basis of the channel quality indicators received from the mobile station and from other mobile stations, frequency blocks to the mobile stations for data transmission.

According to another aspect of the invention, there is provided a mobile telecommunication system utilizing an orthogonal frequency division multiplexing (OFDM) data transmission scheme in which data is transmitted in a plurality of frequency blocks, each frequency block comprising a plurality of OFDM subcarriers. The system comprises a base station comprising a communication interface to provide a wireless connection with a plurality of mobile stations and a processing unit configured to transmit a reference signal to the mobile stations for calculation of a channel quality indicator. The system further comprises a plurality of mobile stations, each comprising a communication interface to provide a wireless connection with the base station, and a processing unit configured to calculate repeatedly a coarse channel quality indicator and at least one defining channel quality indicator for each of the plurality of frequency blocks on the basis of the reference signal received from the base station, to determine a type of channel quality indicator to be transmitted next to the base station, and to transmit either the coarse channel quality indicator or a defining channel quality indicator for each of the plurality of frequency blocks to the base station. The processing unit of the base station is further configured to receive coarse channel quality indicators and defining channel quality indicators from the plurality of mobile stations and to allocate, on the basis of the channel quality indicators received from the mobile stations, frequency blocks to the mobile stations for data transmission.

According to another aspect of the invention, there is provided a base station of a mobile telecommunication system utilizing an orthogonal frequency division multiplexing (OFDM) data transmission scheme in which data is transmitted in a plurality of frequency blocks, each frequency block comprising a plurality of OFDM subcarriers. The base station comprises a communication interface to provide a wireless connection with a plurality of mobile stations being served by the base station, and a processing unit configured to transmit a reference signal to the mobile stations for calculation of one or more channel quality indicators. The processing unit of the base station is further configured to receive coarse channel quality indicators and defining channel quality indicators from the plurality of mobile stations and allocate, on the basis of the channel quality indicators received from the mobile stations, frequency blocks to the mobile stations for data transmission.

According to another aspect of the invention, there is provided a mobile station of a mobile telecommunication system utilizing an orthogonal frequency division multiplexing (OFDM) data transmission scheme in which data is transmitted in a plurality of frequency blocks, each frequency block comprising a plurality of OFDM subcarriers. The mobile station comprises a communication interface to provide a wireless connection with a serving base station. The mobile station further comprises a processing unit configured to calculate repeatedly a coarse channel quality indicator and at least one defining channel quality indicator for each of the plurality of frequency blocks on the basis of the reference signal received from the serving base station, determine the type of channel quality indicator to be transmitted next to the serving base station, and transmit either the coarse channel quality indicator or a defining channel quality indicator for each of the plurality of frequency blocks to the serving base station.

According to another aspect of the invention, there is provided a computer program distribution medium readable by a computer and encoding a computer program of instructions for executing a computer process for high-speed packet data transmission in a base station providing services to a plurality of mobile stations of a mobile telecommunication system utilizing an orthogonal frequency division multiplexing (OFDM) data transmission scheme in which data is transmitted in a plurality of frequency blocks, each frequency block comprising a plurality of OFDM subcarriers. The process comprises transmitting a reference signal to mobile stations for calculation of one or more channel quality indicators. The process further comprises receiving coarse channel quality indicators and defining channel quality indicators from the plurality of mobile stations; and allocating, on the basis of the channel quality indicators received from the mobile stations, frequency blocks to the mobile stations for data transmission.

According to another aspect of the invention, there is provided a computer program distribution medium readable by a computer and encoding a computer program of instructions for executing a computer process for high-speed packet data transmission in a mobile station of a mobile telecommunication system utilizing an orthogonal frequency division multiplexing (OFDM) data transmission scheme in which data is transmitted in a plurality of frequency blocks, each frequency block comprising a plurality of OFDM subcarriers. The process comprises calculating repeatedly a coarse channel quality indicator and at least one defining channel quality indicator for each of the plurality of frequency blocks on the basis of a reference signal received from a serving base station, determining the type of channel quality indicator to be transmitted next from the mobile station to the base station, transmitting either the coarse channel quality indicator or a defining channel quality indicator for each of the plurality of frequency blocks from the mobile station to the serving base station, and allocating, by the serving base station on the basis of the channel quality indicators received from the mobile station and from other mobile stations, frequency blocks to the mobile stations for data transmission.

The invention provides several advantages. The invention provides a solution for employing time staggering as a way to effectively reduce the CQI signaling load and make frequency domain packet scheduling possible within a reasonable signaling bandwidth. The scheduling may be carried out on the basis of available information such that low loaded networks can apply frequency domain multiplexing on the basis of initial reports while it is possible to perform frequency domain scheduling on the basis of the additional incremental information.

### LIST OF DRAWINGS

In the following, the invention will be described in greater detail with reference to embodiments and the accompanying drawings, in which

FIG. 1 illustrates an example of a mobile telecommunication system to which embodiments of the invention can be applied;

FIG. 2 illustrates a channel quality indicator calculation procedure according to an embodiment of the invention, and

FIG. 3 is a flow diagram illustrating a process for high-speed packet data transmission in a mobile telecommunication system according to an embodiment of the invention.

### DESCRIPTION OF EMBODIMENTS

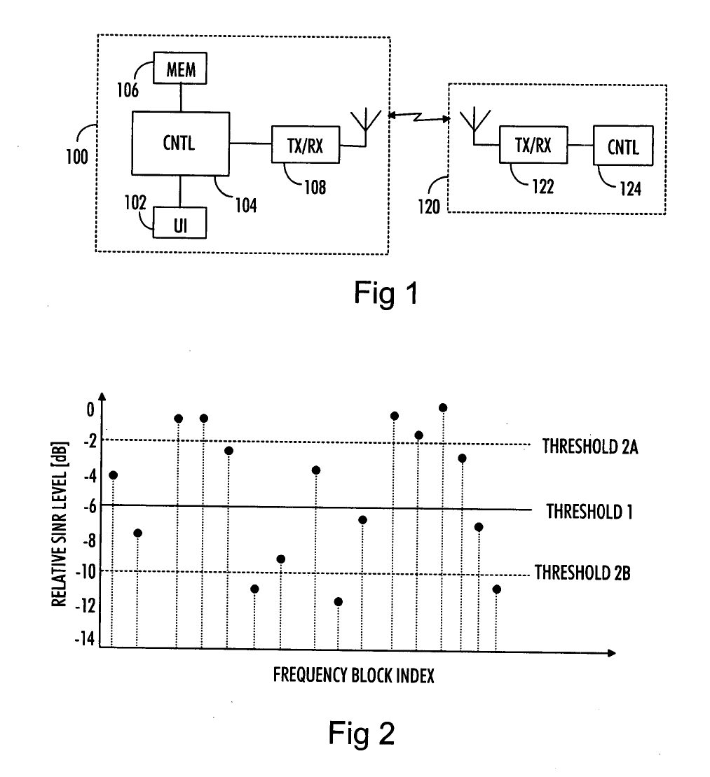

With reference to FIG. 1, examine an example of a mobile telecommunication system to which embodiments of the invention can be applied. The mobile telecommunication system may be a Universal Mobile Telecommunications system (UMTS), for example. The mobile telecommunication system may provide a high-speed packet data service for users of the telecommunication system. The high-speed packet data service may be high-speed downlink packet access (HSDPA) standardized by the 3GPP. The mobile telecommunication system may utilize a multicarrier data transmission scheme, such as Orthogonal Frequency Division Multiplexing (OFDM), for the high-speed packet data service.

With reference to FIG. 1, examine an example of a structure of a mobile station 100 to which embodiments of the invention can be applied. The mobile station 100 in FIG. 1 is a mobile station 100 capable of wireless communications through a radio channel with at least a base station 120 providing services to the mobile station 100. The mobile station 100 may be capable of receiving information transmitted according to an OFDM technique. The mobile station 100 may, for example, be a personal communication or information-processing device, such as a mobile phone or a PDA (Personal Digital Assistant).

The mobile station 100 comprises a communication interface 108 for transmitting and receiving information transmitted through the radio channel. The communication interface 108 may be configured to process received information signals and signals to be transmitted to a certain degree. The communication interface 108 may be configured to filter and amplify received information signals as well as to convert analog information signals into a digital form. The communication interface 108 may be configured convert signals to be transmitted to analog waveforms and transmit the analog waveforms through the radio channel according to the OFDM technique, for example.

The mobile station 100 further comprises a processing unit 104 configured control operations of the mobile station 100. The processing unit 104 may be configured to process information received through the communication interface 108. In particular, the processing unit 104 may be configured to perform digital signal processing algorithms on the received information in order to determine the quality of the radio channel between the mobile station and the serving base station on the basis of a received reference signal. The reference signal may be a pilot signal for training sequence based channel quality estimation or a data signal for data aided channel quality estimation. The processing unit 104 may be implemented with a digital signal processor provided with suitable software embedded on a computer readable medium, or with separate logic circuits, for example with ASIC (Application Specific Integrated Circuit).

The mobile station 100 may further comprise a memory unit 106 for storing information. The memory unit 106 may be of any non-volatile memory type. The memory unit 106 may store software necessary for the operation of the mobile station but also specific parameters necessary for the reception, processing, and transmission of radio signals.

The mobile station 100 may additionally comprise a user interface 102 for interaction between the mobile station and a user of the mobile station 100. The user interface 102 may include an input device such as a keyboard or a keypad, a display device, a microphone, and a loudspeaker.

The serving base station 120 communicating with the mobile station 100 comprises a communication interface 122 and a processing unit 124. The communication interface is configured to provide a communication connection with a plurality of mobile stations the base station 120 is serving within its coverage area. The base station 120 may have the capability of transmitting and receiving information according to the OFDM technique, i.e. have the capability of transmitting multicarrier OFDM signals. The processing unit 124 of the base station 120 is configured to process signals transmitted and received through the communication interface 122. The processing unit may also be configured to carry out radio resource allocation procedures related to the high-speed packet data service provided by the base station 120. The processing unit 124 may be configured to carry out time and frequency scheduling of mobile stations on the basis of channel quality indicators (CQI) transmitted from the mobile stations.

Next, a method of calculating and transmitting CQIs according to an embodiment of the invention will be described. Additionally, it will be described how a base station may utilize these CQIs in allocating radio resources to mobile stations.

The base station may allocate resources to mobile stations in time and in frequency domain. In time domain, the base station schedules the users to transmit or receive data at different time intervals. This is commonly known in the HSDPA service. The utilization of OFDM in packet data transmission enables the scheduling to be carried out also in the frequency domain. This means that, at a given time instant, a total frequency band of an OFDM signal is divided into a plurality of frequency blocks (sometimes referred to as resource blocks) and the frequency blocks are scheduled to a number of mobile stations for data transmission. Each frequency block may be allocated to a different mobile station or multiple frequency blocks may be allocated to some mobile station depending on the radio channel conditions and load in the network. As is commonly known, an OFDM signal consists of a plurality of subcarriers and each subcarrier carries a symbol during an OFDM symbol interval. A frequency block may comprise a plurality, even dozens, of subcarriers. The base station allocates the frequency blocks to the mobile stations receiving the high-speed packet data service on the basis of CQIs received repeatedly from the mobile stations. The mobile stations transmit CQIs with a sufficiently small time interval between successive CQIs so that the base station is constantly aware of the channel conditions of each mobile station receiving the high-speed packet data service.

For calculation of a CQI, the base station transmits a pilot signal on a common pilot channel with a given transmit power level. Since the telecommunication system utilizes OFDM multicarrier data transmission for the high-speed packet data service, the base station may transmit the pilot signal as an OFDM multicarrier signal covering a frequency range utilized for the high-speed packet data service. The pilot signal does not have to be transmitted on every subcarrier of the OFDM multicarrier signal and, thus, it will suffice that the pilot signal is transmitted on given subcarriers having frequency separation that enables determination of frequencies suffering from fading. The frequency range may be divided into frequency blocks with each frequency block comprising a plurality of subcarriers, as described above. The pilot signal may be transmitted on one or more subcarriers of each frequency block.

The mobile stations may have knowledge of the transmit power level the base station uses for the pilot signal. A mobile station receiving a pilot signal may calculate a channel quality metric from the received pilot signal for each of the frequency blocks. The mobile station may also be configured to calculate the channel quality metric for some of the frequency blocks but let us now assume that the mobile station calculates the channel quality metric for every frequency block. The channel quality metric may be a signal-to-interference-plus-noise-power ratio (SINR), for example. Instead of SINR, other metrics may be used as the channel quality metric. The channel quality metrics, e.g. SINRs, may be calculated for each frequency block according to an algorithm known in the art by utilizing the pilot signal on the frequency block the channel quality metric is calculated for. An example of calculated channel quality metrics are illustrated as dots in FIG. 2.

The mobile station may also calculate the channel quality metrics from a received data signal. This type of channel quality estimation is referred to as data aided channel quality estimation. This description, however, focuses on describing the calculation of the channel quality metrics from the received pilot signal for simplicity.

In FIG. 2, the vertical axis defines the relative SINR level (it is assumed that SINR is used as the channel quality metric) of the calculated channel quality metrics. The term ‘relative’ refers to the SINR level calculated from the received pilot signal in relation to a SINR level calculated from a pilot signal which has not attenuated at all in the radio channel, i.e. having the transmit power level. The horizontal axis defines a frequency block index.

Now that the mobile station has calculated the channel quality metric for each frequency block, it may determine the channel quality by quantizing the channel quality metrics. If the channel quality metrics were transmitted as such to the base station, it would require several bits for each channel quality metric (each frequency block) to define the channel quality. That would lead to increased signaling which would degrade the performance of the telecommunication system and lead to increased power consumption in the mobile station. The mobile station may quantize the channel quality metrics by comparing the channel quality metrics to threshold levels. At first, the mobile station may compare a channel quality metric to a first threshold level (threshold 1 in FIG. 2). If the channel quality metric is higher than the first threshold level, the mobile station may store bit value 1 for the channel quality metric. On the other hand, if the channel quality metric is lower than the first threshold level, the mobile station may store bit value 0 for the channel quality metric. This comparison is carried out for every channel quality metric, i.e. for every frequency block. Now, the mobile station has stored one bit value describing the channel quality for each frequency block. This one bit value may be defined as a coarse channel quality indicator (CQI), since it gives a coarse indication defining whether the quality of a given frequency block is ‘good’ or ‘bad’. Referring to FIG. 2, the frequency blocks having the channel quality metric (dot) above the first threshold level are considered to have a good channel quality and the frequency blocks having the channel quality metric (dot) below the first threshold level are considered to have a bad channel quality.

In order to improve the resolution of the CQI, the mobile station may compare each channel quality metric to a second threshold level. Setting the second threshold level depends on the value of each channel quality metric with respect to the first threshold level. For a given channel quality metric, the second threshold level is set to be higher than the first threshold level (threshold 2A), if the channel quality metric was higher than the first threshold level. On the contrary, the second threshold level is set to be lower than the first threshold level (threshold 2B), if the channel quality metric was lower than the first threshold level. Referring to FIG. 2, threshold 2A is used for every channel quality metric above threshold 1, and threshold 2B is used for every channel quality metric below threshold 1.

Let us consider a channel quality metric above the first threshold level. As mentioned above, a coarse CQI having bit value 1 was stored for the channel quality metric. Now, the channel quality metric is compared with threshold 2A. If the value of the channel quality metric is higher than threshold 2A, bit value 1 may be stored for the channel quality metric. On the other hand, if the value of the channel quality metric is lower than threshold 2A, bit value 0 may be stored for the channel quality metric. This comparison is carried out for every channel quality metric, i.e. for every frequency block, above threshold 1. A corresponding comparison is carried out for the channel quality values below threshold 1. The only difference is that the comparison is carried out with threshold 2B. If a given channel quality metric has a value that is higher than threshold 2B, bit value 1 is stored for the channel quality metric, and 0 otherwise. This second bit value may be defined as a defining CQI. Now, the channel quality of each frequency block is defined with two bits according to Table 1 below:

TABLE 1

Channel quality

| | Good | Fair | Bad | Not usable |
|---|---|---|---|---|
| Bit value | 11 | 10 | 01 | 00 |

The first bit is the coarse CQI and the latter bit is the defining CQI. It should be noticed here that defining each channel quality with given bit values (good channel quality with bit values 11, for example) is just a matter of notation and other notations may be used as well.

The mobile station may further improve the resolution of the CQIs by defining next threshold levels (four threshold levels on the next stage) and comparing the channel quality metrics with one of the threshold levels, depending on the previous comparison. For example, if a channel quality metric was higher than the first threshold level (threshold 1) but lower than the second threshold level (threshold 2A), the new threshold level is set between thresholds 1 and 2A for this channel quality metric. Accordingly, a third bit further defining the channel quality is obtained for every frequency block. This way, the mobile station may calculate the CQIs with an arbitrary resolution. In this description, channel quality is described by using a two-bit resolution, since it does not obscure the description with unnecessary details.

Now, the mobile station has the coarse CQI (the first bit) and the defining CQI (the second bit) for every frequency block. First, the mobile station may transmit the coarse channel quality indicator to the base station so that the base station may use the coarse CQI when allocating the frequency blocks to the mobile station and other mobile stations for data transmission. The coarse CQI report may be transmitted, for example, with the structure described in Table 2 below. Let us assume that the total frequency band of the OFDM signal is divided into 48 frequency blocks.

TABLE 2

| Overall CQI | Relative offset | CQI report | Bit mask for blocks |
|---|---|---|---|
| 5 bits | 2 bits | 1 bit | 48 bits |

In Table 2, the overall CQI may describe an expected reception SINR at the mobile station for frequency blocks having a good channel quality. It may also describe an indirect measure of the channel quality, such as a supported data rate. The relative offset bits may indicate the thresholds that have been used in the calculation of the CQIs. Assuming that the relative offset is defined with two bits, the possible thresholds could be, for example, −2, 4, −6, −8 dB. In our example in FIG. 2, the first threshold level was set to −6 dB. Accordingly, this threshold level would be indicated with the two bits of the relative offset. A CQI report counter indicates whether it is the coarse or the defining CQI that is transmitted in this CQI report. If the threshold levels are fixed, determined by the base station, it is not necessary to signal the relative offset bits. A bit mask is used for transmitting the coarse CQI of every frequency block. Accordingly, the bit values stored when comparing the channel quality metrics with the first threshold level are transmitted in the bit mask. The mobile station may be configured to transmit the coarse and defining CQI reports at defined time instants. This is referred to as synchronous operation, which means that the mobile station is synchronized with the base station.

After the coarse CQI report has been transmitted, the mobile station may transmit a defining CQI report as the next CQI report. The defining CQI report may have the structure described in Table 2, but now the bits in the bit mask comprise the defining CQIs for every frequency block. Accordingly, the bit values stored when comparing the channel quality metrics with the second threshold level (threshold 2A or 2B) are transmitted in the bit mask. The relative offset bits may now define, for example, the threshold level offset relative to the first threshold level. Since the first threshold level was −6 dB and the second threshold level were −2 and −10 dB in FIG. 2, the offset relative to the first threshold level is ±4 dB. Alternatively, absolute threshold levels may be indicated. The overall CQI may have the same function as in the coarse CQI report. Alternatively, it may now describe the expected reception SINR at the mobile station for frequency blocks having a fair channel quality, for example. Other utilizations of the overall CQI are naturally also possible.

The mobile station may transmit the coarse CQI report as soon as it has calculated the coarse CQIs for every frequency block, or it may first calculate both the coarse and the defining CQIs and then transmit the CQIs successively. This is just a matter of implementation.

The mobile station may transmit alternately a coarse CQI report and a defining CQI report (or defining CQI reports, if the resolution is more than two bits) under normal channel conditions. In special cases, the mobile station may transmit the coarse CQI reports successively. This means that the mobile station transmits only a coarse channel quality indication without further defining the channel qualities of the frequency blocks. The mobile station may be configured to transmit only the coarse CQI report under rapidly changing channel conditions, for example. Thus, the base station receives new CQI reports at a fast pace and will be able to adapt to the channel conditions. The channel conditions may be determined from the channel quality metrics calculated for each frequency block.

The base station receives the CQI reports from the mobile station and from other mobile stations it is serving. The base station may determine the type of a received CQI report on the basis of the CQI report counters contained in the CQI report. In the synchronous operation, the base station may determine the type of the received CQI report from the time instant at which it received the CQI report. The base station may determine the channel qualities of the frequency blocks on the basis of the relative offset bits and the bit masks included in the report. As mentioned above, if the threshold levels are fixed, the base station determines the channel qualities on the basis of the bit mask.

When the base station receives a coarse CQI report from the mobile station, it may allocate frequency blocks to the mobile station on the basis of the coarse CQI report (on the basis of one bit in the bit mask per every frequency block). Now the base station only roughly knows on which frequency blocks the mobile station is able to receive with high performance. When the base station receives a defining CQI report from the mobile station, it may combine the bits in the bit mask of the defining CQI report with the corresponding bits in the bit mask of the coarse CQI report. Now, the base station has more detailed information (with 2-bit resolution) on the channel qualities of the frequency blocks. Accordingly, the base station may reallocate the frequency blocks for the mobile station on the basis of the new and more defining information contained in the defining CQI report. The base station may carry out a similar procedure for other mobile stations transmitting coarse and defining CQI reports.

The base station may also utilize the received CQI reports in determining a modulation and coding scheme for the mobile station. This may be carried out on the basis of the overall CQIs and the bit masks in the received CQI reports. For example, a mobile station located close to the base station would probably have an overall channel quality metric indicating that 16QAM with only marginal channel coding (or even 64QAM, if this option exists) should be used for the good frequency blocks. If other frequency blocks are chosen, either a stronger channel coding or another modulation scheme should be used in order to keep the packet error performance at a predetermined level. On the other hand, a mobile station located close to a cell edge (and thus having a high path loss) would have a quality metric indicating that the mobile station can support QPSK at most. Thus, it would not make sense to use even the fair, bad and unusable frequency blocks.

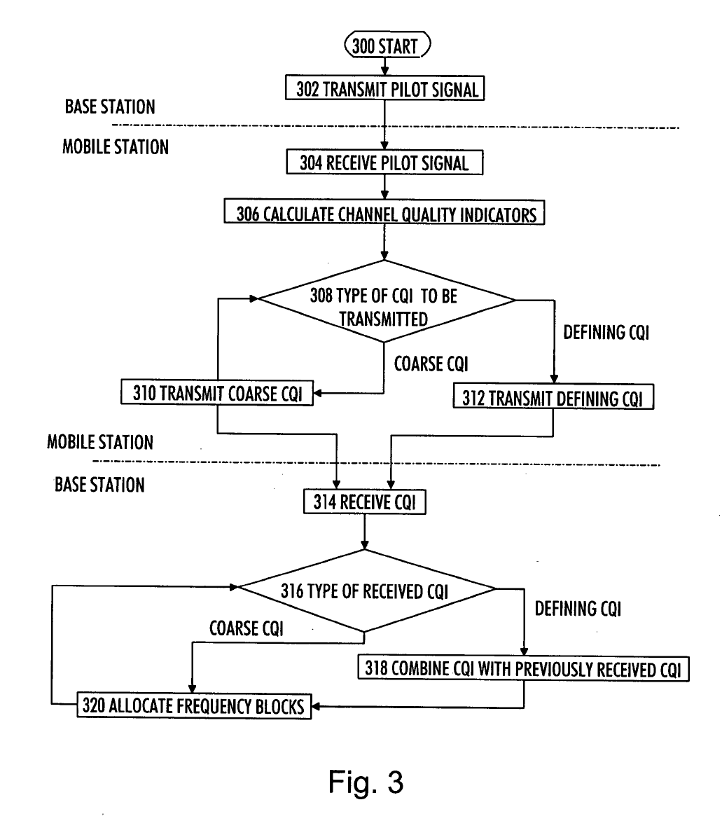

Next, a process for calculating CQIs and allocating frequency blocks for high-speed packet data transmission is described with reference to the flow diagram of FIG. 3. The process starts in block 300. In block 302, a base station transmits a pilot signal with a given transmit power level. The pilot signal may be transmitted on a given subcarrier or subcarriers of each frequency block utilized in the data transmission.

In block 304, a mobile station receives the pilot signal. In block 306, a processing unit of the mobile station calculates a coarse channel quality indicator and a defining channel quality indicator for every frequency block from the received pilot signal. The coarse CQIs and the defining CQIs may be calculated by calculating a quality metric (SINR) for every frequency block and comparing the quality metric with given threshold levels, as described above. Then, the mobile station determines which type of CQI report should be transmitted to the base station. The mobile station may transmit either a coarse CQI report comprising the coarse CQIs or a defining CQI report comprising the defining CQIs. The mobile station may transmit the defining CQI report only after the coarse CQI report. If the mobile station determines that it is the coarse CQI report that should be transmitted, the process moves to block 310 in which the mobile station transmits the coarse CQI report. From block 310, the process returns to block 308 for determining the type of the CQI report to be transmitted next. Meanwhile, the mobile station may have calculated another set of coarse CQIs defining a coarse channel quality for every frequency block on the basis of a newly received pilot signal. If, in block 308, the mobile station determines that a defining CQI report should be transmitted, the process moves to block 312 in which the mobile station transmits the defining CQI reports comprising the defining CQIs further defining the channel qualities indicated by the previously transmitted coarse CQI report.

In block 314, the base station receives a CQI report from the mobile station. In block 316, a processing unit of the base station determines the type of the received CQI report. If the received CQI report is a coarse CQI report, the process moves to block 320 in which the base station allocates frequency block to the mobile station for data transmission. The base station allocates the frequency blocks on the basis of the received coarse CQI report. From block 320, the process returns to block 316 for processing the next CQI report.

If the received CQI report is a defining CQI report, the process moves from block 316 to block 318 in which the base station combines the defining CQIs in the received defining CQI report with the corresponding coarse CQIs in the previously received coarse CQI report in order to improve the resolution of the CQIs received from the mobile station. Next, the process moves to block 320 in which the base station reallocates the frequency blocks to the mobile station for high-speed packet data transmission on the basis of the additional information provided by the defining CQI report.

The embodiments of the invention may be implemented as computer programs in a base station and a mobile station according to an embodiment of the invention. The computer programs comprise instructions for executing a computer process for high-speed packet data transmission in a mobile telecommunication system utilizing an OFDM data transmission scheme in which data is transmitted in a plurality of frequency blocks, each frequency block comprising a plurality of OFDM subcarriers. The computer program implemented in the mobile station may configure the mobile station to carry out calculation of CQIs according to embodiments of the invention described above by referring to FIG. 2 and to blocks 304 to 312 in FIG. 3. The computer program implemented in the base station may configure the base station to carry out reception and processing of CQIs received from a plurality of mobile stations according to embodiments of the invention as described above. The computer program implemented in the base station may configure the base station to carry out operations related to blocks 302 and 314 to 320 in FIG. 3.

The computer programs implemented in the mobile station and in the base station may be stored on a computer program distribution medium readable by a computer or a processor. The computer program medium may be, for example but not limited to, an electric, magnetic, optical, infrared or semiconductor system, device or transmission medium. The computer pro gram medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings it is clear that the invention is not restricted thereto but it can be modified in several ways within the scope of the appended claims.

1. A high-speed packet data transmission method in a mobile telecommunication system utilizing an orthogonal frequency division multiplexing (OFDM) data transmission scheme in which data is transmitted in a plurality of frequency blocks, each frequency block comprising a plurality of OFDM subcarriers, the method comprising:
calculating, by a mobile station of the mobile telecommunication system, repeatedly a coarse channel quality indicator and at least one defining channel quality indicator for each of the plurality of frequency blocks on the basis of a reference signal transmitted from a serving base station to the mobile station;
determining a type of channel quality indicator to be transmitted next from the mobile station to the base station;
transmitting either the coarse channel quality indicator or a defining channel quality indicator for each of the plurality of frequency blocks from the mobile station to the serving base station, and
allocating, by the serving base station on the basis of channel quality indicators received from the mobile station and from other mobile stations, frequency blocks to the mobile stations for data transmission.

2. The method of claim 1, further comprising: improving resolution of channel quality indicated by the coarse channel quality indicator with the defining channel quality indicator or indicators.

3. The method of claim 1, the calculation of the channel quality indicators for one frequency block comprising:
calculating a channel quality metric;
determining the coarse channel quality indicator by comparing the calculated channel quality metric to a first threshold level, and
determining a detailed channel quality metric by comparing the calculated channel quality metric to a second threshold level.

4. The method of claim 3, further comprising setting the second threshold level to be higher than the first threshold level, if the channel quality indicator is higher than the first threshold level, and lower than the first threshold level, if the channel quality indicator is lower than the first threshold level.

5. The method of claim 1, further comprising transmitting, within the channel quality indicator, an indication defining the type of the channel quality indicator.

6. The method of claim 1, further comprising combining, by the serving base station, the received at least one defining channel quality indicator received after the coarse channel quality indicator with the received coarse channel quality indicator in order to improve resolution of channel quality indication provided by the mobile station.

7. The method of claim 1, further comprising determining that the coarse channel indicator and the defining channel quality indicator are to be transmitted alternately under a normal channel condition and that only the coarse channel quality indicator is to be transmitted under rapidly changing channel conditions.

8. The method of claim 1, wherein the reference signal is a pilot signal.

9. A mobile telecommunication system utilizing an orthogonal frequency division multiplexing (OFDM) data transmission scheme in which data is transmitted in a plurality of frequency blocks, each frequency block comprising a plurality of OFDM subcarriers, comprising:
a base station comprising a communication interface to provide a wireless connection with a plurality of mobile stations and a processing unit configured to transmit a reference signal to the mobile stations for calculation of a channel quality indicator; and
a plurality of mobile stations, each comprising a communication interface to provide a wireless connection with the base station, and a processing unit configured to calculate repeatedly a coarse channel quality indicator and at least one defining channel quality indicator for each of the plurality of frequency blocks on the basis of the reference signal received from the base station, to determine a type of channel quality indicator to be transmitted next to the base station, and to transmit either the coarse channel quality indicator or a defining channel quality indicator for each of the plurality of frequency blocks to the base station, and
the processing unit of the base station is further configured to receive coarse channel quality indicators and defining channel quality indicators from the plurality of mobile stations and to allocate, on the basis of the channel quality indicators received from the mobile stations, frequency blocks to the mobile stations for data transmission.

10. The system of claim 9, wherein the defining channel quality indicator or indicators are used for improving resolution of channel quality indicated by the coarse channel quality indicator.

11. The system of claim 9, wherein the processing unit of each mobile station is further configured to calculate the channel quality indicators for one frequency block by calculating a channel quality metric, to determine the coarse channel quality indicator by comparing the calculated channel quality metric to a first threshold level, and to determine a detailed channel quality metric by comparing the calculated channel quality metric to a second threshold level.

12. The system of claim 11, wherein the processing unit is further configured to determine the second threshold level to be higher than the first threshold level, if the channel quality indicator is higher than the first threshold level, and lower than the first threshold level, if the channel quality indicator is lower than the first threshold level.

13. The system of claim 9, wherein the processing unit of each mobile station is further configured to transmit, within the channel quality indicator, an indication defining the type of the channel quality indicator.

14. The system of claim 9, wherein the processing unit of each mobile station is further configured to determine that the coarse channel indicator and the defining channel quality indicator are to be transmitted alternately under a normal channel condition and that only the coarse channel quality indicator is to be transmitted under rapidly changing channel conditions.

15. The system of claim 9, wherein the reference signal is a pilot signal.

16. The system of claim 9, wherein the processing unit of the base station is further configured to combine the received at least one defining channel quality indicator received from a given mobile station after the coarse channel quality indicator with a received coarse channel quality indicator in order to improve resolution of channel quality indication provided by the mobile station.

17. A base station of a mobile telecommunication system utilizing an orthogonal frequency division multiplexing (OFDM) data transmission scheme in which data is transmitted in a plurality of frequency blocks, each frequency block comprising a plurality of OFDM subcarriers, comprising:
a communication interface to provide a wireless connection with a plurality of mobile stations being served by the base station, and
a processing unit configured to transmit a reference signal to the mobile stations for calculation of one or more channel quality indicators, to receive coarse channel quality indicators and defining channel quality indicators from the plurality of mobile stations, and to allocate, on the basis of the channel quality indicators received from the mobile stations, frequency blocks to the mobile stations for data transmission.

18. A mobile station of a mobile telecommunication system utilizing an orthogonal frequency division multiplexing (OFDM) data transmission scheme in which data is transmitted in a plurality of frequency blocks, each frequency block comprising a plurality of OFDM subcarriers, comprising:
a communication interface to provide a wireless connection with a serving base station, and
a processing unit configured to calculate repeatedly a coarse channel quality indicator and at least one defining channel quality indicator for each of the plurality of frequency blocks on the basis of a reference signal received from the serving base station, to determine a type of channel quality indicator to be transmitted next to the serving base station, and to transmit either the coarse channel quality indicator or a defining channel quality indicator for each of the plurality of frequency blocks to the serving base station.

19. A computer program distribution medium readable by a computer and encoding a computer program of instructions for executing a computer process for high-speed packet data transmission in a base station providing services to a plurality of mobile stations of a mobile telecommunication system utilizing an orthogonal frequency division multiplexing (OFDM) data transmission scheme in which data is transmitted in a plurality of frequency blocks, each frequency block comprising a plurality of OFDM subcarriers, the process comprising:
transmitting a reference signal to mobile stations for calculation of one or more channel quality indicators;
receiving coarse channel quality indicators and defining channel quality indicators from the plurality of mobile stations; and
allocating, on the basis of the channel quality indicators received from the mobile stations, frequency blocks to the mobile stations for data transmission.

20. The computer program distribution medium of claim 19, the distribution medium including at least one of the following media: a computer readable medium, a program storage medium, a record medium, a computer readable memory, a computer readable software distribution package, a computer readable signal, a computer readable telecommunications signal, and a computer readable compressed software package.

21. A computer program distribution medium readable by a computer and encoding a computer program of instructions for executing a computer process for high-speed packet data transmission in a mobile station of a mobile telecommunication system utilizing an orthogonal frequency division multiplexing (OFDM) data transmission scheme in which data is transmitted in a plurality of frequency blocks, each frequency block comprising a plurality of OFDM subcarriers, the process comprising:
calculating repeatedly a coarse channel quality indicator and at least one defining channel quality indicator for each of the plurality of frequency blocks on the basis of a reference signal received from a serving base station;
determining a type of channel quality indicator to be transmitted next from the mobile station to the base station;
transmitting either the coarse channel quality indicator or a defining channel quality indicator for each of the plurality of frequency blocks from the mobile station to the serving base station, and
allocating, by the serving base station on the basis of channel quality indicators received from the mobile station and from other mobile stations, frequency blocks to the mobile stations for data transmission.

22. The computer program distribution medium of claim 21, the distribution medium including at least one of the following media: a computer readable medium, a program storage medium, a record medium, a computer readable memory, a computer readable software distribution package, a computer readable signal, a computer readable telecommunications signal, and a computer readable compressed software package.
